(19) United States
(12) Patent Application Publication
(10) Pub. No.: US 2026/0252239 A1
(43) Pub. Date: Aug. 27, 2026

(54) CONTROL METHOD OF FLASH MEMORY CONTROLLER FOR BANDWIDTH ADJUSTMENT

(71) Applicant: Silicon Motion, Inc., Hsinchu County (TW)

(72) Inventors: Che-Min Lin, Hsinchu City (TW); Feng-Chun Kuo, Hsinchu City (TW); Chun-Cheng Lee, Yilan County (TW)

(73) Assignee: Silicon Motion, Inc., Hsinchu County (TW)

(21) Appl. No.: 19/063,372

(22) Filed: Feb. 26, 2025

(51) Int. Cl. G06F 3/06

(52) U.S. Cl. CPC G06F 3/0613; G06F 3/0655; G06F 3/0679

(57) ABSTRACT

The present invention provides a control method of a flash memory controller. The flash memory controller is coupled between a host device and a flash memory module, and the flash memory controller is configured to receive a command from the host device to access the flash memory module; and the control method includes the steps of: setting a first bandwidth for communicating with the host device; receiving a specific command from the host device; and transmitting a bandwidth change request to the host device to negotiate with the host device to set a second bandwidth for communicating with the host device according to the specific command.

### BACKGROUND OF THE INVENTION

### 1. Field of the Invention

The present invention relates to a flash memory controller.

### 2. Description of the Prior Art

Peripheral Component Interconnect Express (PCIe) is a high-speed interface standard used for connecting various components in computers and servers, such as graphics cards, storage devices, and networking cards. Each version 4 PCIe has introduced improvements in bandwidth and performance. For example, bandwidth per lane of PCIe 3.0 is 8 GT/s (Giga-transfers per second), bandwidth per lane of PCIe 4.0 is 16 GT/s, and bandwidth per lane of PCIe 5.0 is 32 GT/S.

A solid state drive (SSD) is a type of storage device that uses NAND flash memory to store data, providing faster access speeds, higher durability, and lower power consumption compared to traditional Hard Disk Drives (HDDs). The PCIe interface plays a crucial role in connecting SSDs to a host device such as computer's motherboard, enabling high-speed data transfer and enhancing overall system performance.

In conventional SSDs with a PCIe interface, when the SSD connects to the host device, both are configured to the maximum allowable bandwidth or a default bandwidth. For instance, if the SSD supports PCIe 5.0, the SSD and the host device will be set to a bandwidth of 32 GT/s per lane. This configuration remains in place for all data transmission and reception. However, due to the variability in user interaction with electronic devices, such as merely watching online videos or typing on a computer, the data transfer between the host device and the SSD may be minimal. In these situations, maintaining a high-bandwidth configuration, which consumes more energy, will result in unnecessary energy waste.

In addition, the bandwidth of the PCIe interface is always determined by the host device. However, the host device may not have enough information for determining the most suitable bandwidth.

### SUMMARY OF THE INVENTION

Therefore, one of the objectives of this invention is to propose a flash memory controller, which can control bandwidth adjustment between the flash memory controller and the host device, to solve the above problems described in the prior art.

According to one embodiment of the present invention, a control method of a flash memory controller is disclosed. The flash memory controller is coupled between a host device and a flash memory module, and the flash memory controller is configured to receive a command from the host device to access the flash memory module; and the control method comprises: setting a first bandwidth for communicating with the host device; receiving a specific command from the host device; and transmitting a bandwidth change request to the host device to negotiate with the host device to set a second bandwidth for communicating with the host device according to the specific command.

According to one embodiment of the present invention, a flash memory controller configured to receive a command from a host device to access a flash memory module is disclosed. The flash memory controller comprises a read-only memory, a microprocessor and an interface logic, wherein the microprocessor is configured to execute the program code to control access of the flash memory module, and the interface logic is coupled between the microprocessor and the host device. The microprocessor and the interface logic are configured to perform the steps of: setting a first bandwidth for communicating with the host device; receiving a specific command from the host device; and transmitting a bandwidth change request to the host device to negotiate with the host device to set a second bandwidth for communicating with the host device according to the specific command.

According to one embodiment of the present invention, a memory device comprising a flash memory module and a flash memory controller configured to receive a command from a host device to access the flash memory module is disclosed. The flash memory controller is configured to perform the steps of: setting a first bandwidth for communicating with the host device; receiving a specific command from the host device; and transmitting a bandwidth change request to the host device to negotiate with the host device to set a second bandwidth for communicating with the host device according to the specific command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a memory device according to an embodiment of the present invention.

FIG. 2 is a diagram illustrating a control method of the flash memory controller and the host device according to one embodiment of the present invention.

FIG. 3 is a diagram illustrating the bandwidth adjustment according to one embodiment of the present invention.

FIG. 4 is a diagram illustrating a control method of the flash memory controller and the host device according to one embodiment of the present invention.

FIG. 5 is a diagram illustrating a control method of the flash memory controller and the host device according to one embodiment of the present invention.

FIG. 6 is a diagram illustrating a specific command for the embodiment shown in FIG. 4 according to one embodiment of the present invention.

FIG. 7 is a diagram illustrating a specific command for the embodiment shown in FIG. 4 according to one embodiment of the present invention.

FIG. 8 is a diagram illustrating a specific command for the embodiment shown in FIG. 2 according to one embodiment of the present invention.

### DETAILED DESCRIPTION

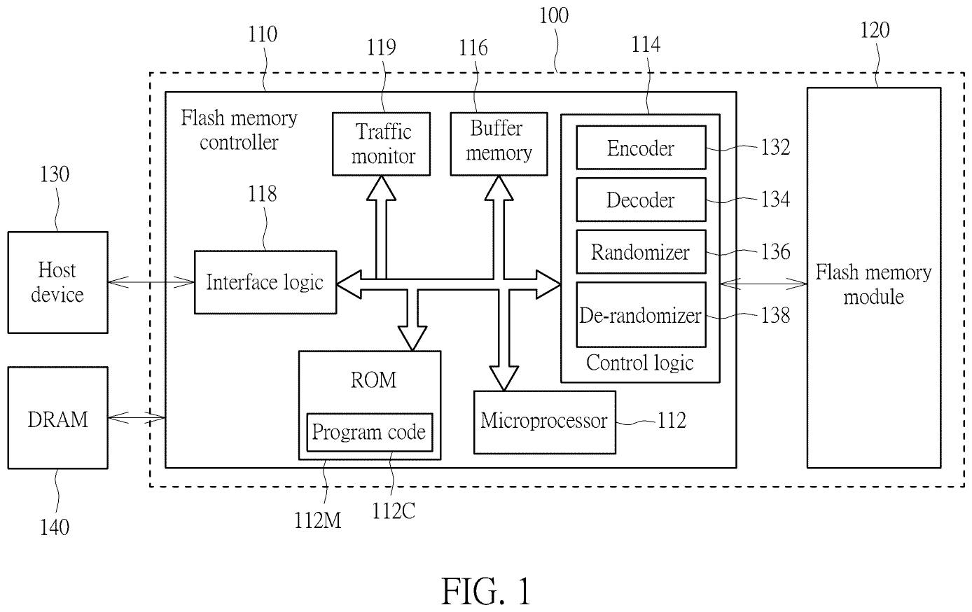

FIG. 1 is a diagram illustrating a memory device 100 according to an embodiment of the present invention. The memory device 100 includes a flash memory module 120 and a flash memory controller 110, wherein the flash memory controller 110 is arranged to access the flash memory module 120. The flash memory controller 110 includes a microprocessor 112, a read only memory (ROM) 112M, a control logic 114, a buffer memory 116, an interface logic 118 and a traffic monitor 119. The ROM 112M is arranged to store a program code 112C, and the microprocessor 112 is arranged to execute the program code 112C to control access of the flash memory module 120. The control logic 114 includes an encoder 132, a decoder 134, a randomizer 136 and a de-randomizer 138. The encoder 132 is arranged to encode data that is written into the flash memory module 120 to generate a corresponding parity (also known as an error correction code (ECC)), and the decoder 134 is arranged to decode data that is read from the flash memory module 120. The randomizer 136 is used to randomize the data written to the flash memory module 120, and the de-randomizer 138 is used to de-randomize the data read from the flash memory module 120.

In a general situation, the flash memory module 120 includes a plurality of flash memory chips, and each flash memory chip includes a plurality of blocks. A controller (e.g. the flash memory controller 110 that executes the program code 112C through the microprocessor 112) may copy, erase, and merge data for the flash memory module 120 with a block as a unit. In addition, a block can record a specific number of pages, wherein the controller (e.g. the flash memory controller 110 that executes the program code 112C through the microprocessor 112) may perform a data write operation upon the flash memory module 120 with a page as a unit. In other words, a block is the smallest erase unit in the flash memory module 120, and a page is the smallest write unit in the flash memory module 120.

In practice, the flash memory controller 110 that executes the program code 112C through the microprocessor 112 may utilize its own internal components to perform many control operations. For example, the flash memory controller 122 utilizes the control logic 114 to control access of the flash memory module 120 (more particularly, access at least one block or at least one page), utilizes the buffer memory 116 and/or a DRAM 140 to perform a required buffering operation, and utilizes the interface logic 118 to communicate with a host device 130.

In one embodiment, the memory device 100 may be a portable memory device such as a memory card which conforms to one of the SD/MMC, CF, MS and XD specifications, and the host device 130 is an electronic device able to be connected to the memory device 100, such as a cellphone, a laptop, a desktop computer, etc. In another embodiment, the memory device 100 can be a solid state drive (SSD) or an embedded storage device conforming to the universal flash storage (UFS) or embedded multi-media card (EMMC) specifications, and can be arranged in an electronic device. For example, the memory device 100 can be arranged in a cellphone, a watch, a portable medical testing device (e.g. a medical wristband), a laptop, or a desktop computer. In this case, the host device 130 can be a processor of the electronic device.

In this embodiment, the flash memory module 120 is a three-dimensional (3D) NAND-type flash memory, in which each block is composed of multiple word lines, multiple bit lines and multiple memory cells. Since the 3D NAND flash memory architecture is well known to those with ordinary knowledge in the art, no further explanation is given in the specification.

The interface logic 118 comprises a PCIe interface that coupled to a PCIe interface within the host device 130. In this embodiment, the flash memory controller 110 can determine a suitable bandwidth (or named link speed) of the PCIe interface by using an active mode or a passive mode, to avoid unnecessary power consumption. In the following description, the active mode means that the flash memory controller 110 itself determines the suitable bandwidth and the time when the bandwidth is adjusted; and the passive mode means that the flash memory controller 110 receives the bandwidth adjustment instruction from the host device 130, and the flash memory controller 110 determines the time when the bandwidth is adjusted.

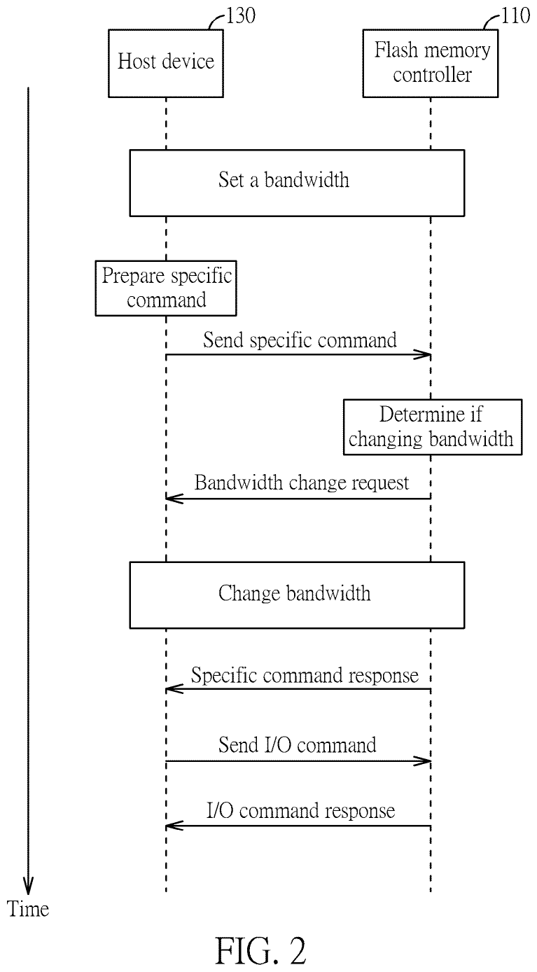

FIG. 2 is a diagram illustrating a control method of the flash memory controller 110 and the host device 130 according to one embodiment of the present invention, wherein the flash memory controller 110 uses the above-mentioned active mode to control the bandwidth. Initially, the flash memory controller 110 and the host device 130 have negotiated to have a bandwidth, where the bandwidth may correspond to any one of multiple PCIe generations. For example, the PCIe interface of the interface logic 118 may be configured to have bandwidth equal to 2.5 GT/s corresponding to PCIe 1.0 (PCIe generation 1), 5 GT/s corresponding to PCIe 2.0 (PCIe generation 2), 8 GT/s corresponding to PCIe 3.0 (PCIe generation 3), 16 GT/s corresponding to PCIe 4.0 (PCIe generation 4), 32 GT/s corresponding to PCIe 5.0 (PCIe generation 5), or 64 GT/s corresponding to PCIe 6.0 (PCIe generation 6). Then, the host device 130 prepares a specific command, where the specific command may be a PCIe admin command, and the specific command is used to enable the bandwidth adjustment mechanism of the flash memory controller 110. After the specific command is established, the host device 130 sends the specific command to the flash memory controller 110.

Then, the flash memory controller 110 determines if any other bandwidth is more suitable than the current bandwidth, if yes, the flash memory controller 110 transmits a bandwidth change request to the host device 130. In this embodiment, the flash memory controller 110 may refer to at least one of the following information to determine the suitable bandwidth for data transmission between the flash memory controller 110 and the host device 130: the number of commands in a queue (i.e., the number of commands that have not been executed by the flash memory controller 110), or a current operation of the flash memory controller 110.

In one embodiment, the greater the number of commands in the queue, the more data the flash memory controller 110 needs to receive from the host device 130, so the flash memory controller 130 will determine that higher bandwidth is needed. For example, the flash memory controller 110 may compare the number of commands in the queue with at least one threshold value to determine the suitable bandwidth, and if it is determined that the current bandwidth is not the most suitable bandwidth for the flash memory controller 110, the flash memory controller 110 sends a bandwidth change request with a recommended bandwidth to the host device 130, to negotiate with the host device 130 to have the recommended bandwidth or another bandwidth.

In one embodiment, the flash memory controller 110 may only use part of bandwidth with the host device 130 while performing some special operations such as garbage collection operations. Therefore, when the flash memory controller 110 is performing the garbage collection to move valid data within one or more blocks to a blank block, the flash memory controller 110 may send a bandwidth change request with a recommended bandwidth lower than the current bandwidth, if any, to the host device 130, to negotiate with the host device 130 to have the lower bandwidth to avoid unnecessary power consumption.

In addition, to prevent the packet loss during the bandwidth adjustment, the flash memory controller 130 may halt the packet transmission, if any, with the host device 130 first, then send the bandwidth change request with a recommended bandwidth to the host device 130.

After the flash memory controller 110 negotiates with the host device 130 to have a new bandwidth, the flash memory controller sends a specific command response to the host device 130. Then, the host device uses the new bandwidth setting to send I/O commands to the flash memory controller 110, and the flash memory controller 110 uses the new bandwidth setting to send the I/O command response to the host device 130.

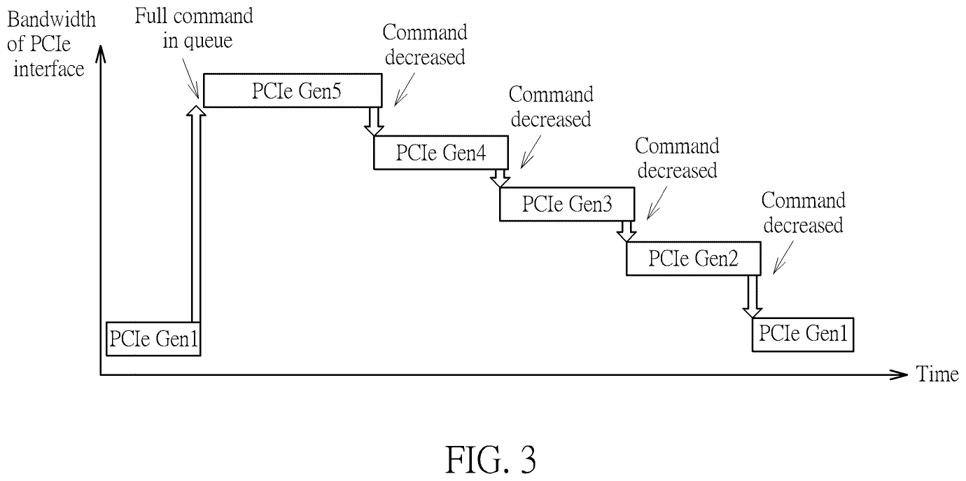

FIG. 3 is a diagram illustrating the bandwidth adjustment according to one embodiment of the present invention. As shown in FIG. 2, initially the flash memory controller 110 begins to perform garbage collection operation, so the flash memory controller 110 has negotiated with the host device 130 to have the bandwidth corresponding to PCIe 1.0. Then, the host device 130 suddenly writes many input/output (I/O) commands (e.g., read commands and/or write commands) so that the queue is full of commands. Because the queue stores many I/O commands, such as the number of commands in the queue is greater than a first threshold, the flash memory controller 110 determines that the most suitable bandwidth should correspond to PCIe 5.0, so that the flash memory controller 110 negotiates with the host device 130 to have the bandwidth corresponding to PCIe 5.0. As the flash memory controller 110 continuously executes commands, the number of commands in the queue gradually decreases. The flash memory controller 110 negotiates sequentially with the host device 130 to reduce the bandwidth, for example, decreasing the bandwidth from PCIe 5.0 to PCIe 1.0.

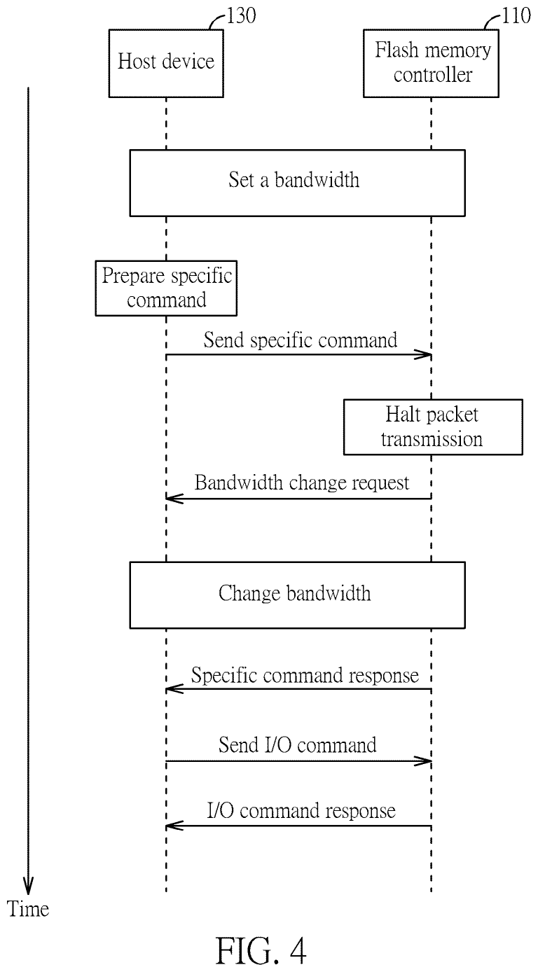

FIG. 4 is a diagram illustrating a control method of the flash memory controller 110 and the host device 130 according to one embodiment of the present invention, wherein the flash memory controller 110 uses the above-mentioned passive mode to control the bandwidth. Initially, the flash memory controller 110 and the host device 130 have negotiated to have a bandwidth, where the bandwidth may correspond to any one of multiple PCIe generations. For example, the PCIe interface of the interface logic 118 may be configured to have bandwidth equal to 2.5 GT/s corresponding to PCIe 1.0, 5 GT/s corresponding to PCIe 2.0, 8 GT/s corresponding to PCIe 3.0, 16 GT/s corresponding to PCIe 4.0, 32 GT/s corresponding to PCIe 5.0, or 64 GT/s corresponding to PCIe 6.0. Then, the host device 130 prepares a specific command, where the specific command may be a PCIe admin command, and the specific command is used to enable the bandwidth adjustment mechanism of the flash memory controller 110, and the specific command further comprises a recommended bandwidth. In this embodiment, the host device 130 may refer to the configuration of memory device 100 and/or the user's setting to determine the recommended bandwidth. After the specific command is established, the host device 130 sends the specific command with the recommended bandwidth to the flash memory controller 110.

After receiving the specific command from the host device 130, in order to prevent the packet loss during the bandwidth adjustment, the flash memory controller 130 may halt the packet transmission, if any, with the host device 130 first, then send the bandwidth change request to the host device 130.

After the flash memory controller 110 negotiates with the host device 130 to have a new bandwidth, the flash memory controller sends a specific command response to the host device 130. Then, the host device uses the new bandwidth setting to send I/O commands to the flash memory controller 110, and the flash memory controller 110 uses the new bandwidth setting to send the I/O command response to the host device 130.

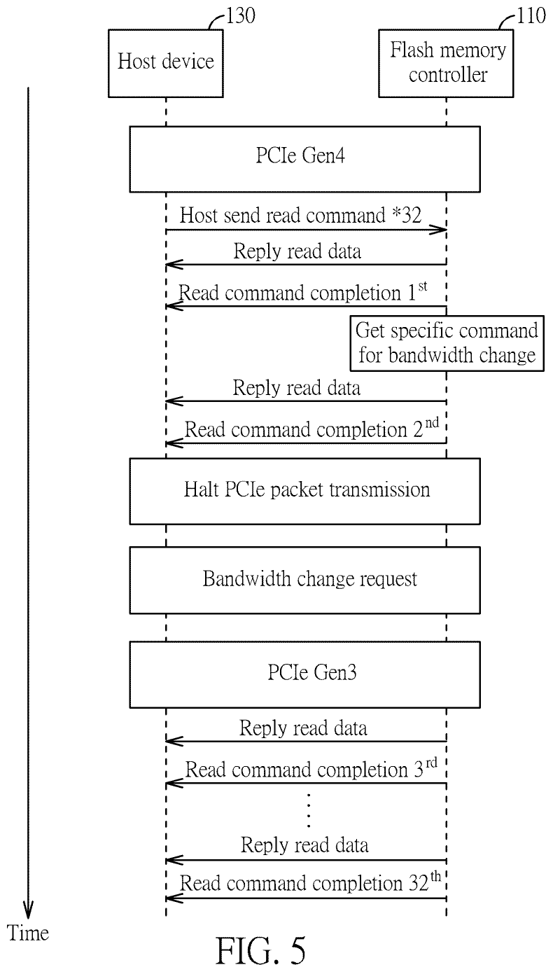

FIG. 5 is a diagram illustrating a control method of the flash memory controller 110 and the host device 130 according to one embodiment of the present invention, wherein the flash memory controller 110 can use the above-mentioned passive mode or active mode to control the bandwidth. Initially, the flash memory controller 110 and the host device 130 have negotiated to have a bandwidth, where the bandwidth may correspond to any one of multiple PCIe generations, such as PCIe 4.0 shown in FIG. 5. Then, the host device 130 sends multiple I/O commands such as thirty-two read commands to the flash memory controller 110, and the flash memory controller 110 sequentially executes the commands and replies the corresponding data to the host device 130.

In the embodiment shown in FIG. 5, the flash memory controller 110 receives a specific command from the host device 130, wherein the specific command can correspond the embodiment shown in FIG. 2 or FIG. 4, that is, the specific command can be used to enable the bandwidth adjustment mechanism of the flash memory controller 110 without the recommended bandwidth, or the specific command can be used to enable the bandwidth adjustment mechanism of the flash memory controller 110 with the recommended bandwidth. After receiving the specific command from the host device 130, the flash memory controller 110 executes the first read command and replies the read data to the host device 130.

After executing the 2^{nd} read command and replies the read data to the host device 130, the flash memory controller 110 halts PCIe packet transmission, that is the flash memory controller 110 does not receive packet from the host device 130 or transmit packet to the host device 130.

Then, if the specific command sent from the host device 130 does not include the recommended bandwidth, the flash memory controller 110 determines if any other bandwidth is more suitable than the current bandwidth, if yes, the flash memory controller 110 transmits a bandwidth change request with the recommended bandwidth to the host device 130 to adjust the PCIe bandwidth. If the specific command sent from the host device 130 includes the recommended bandwidth, the flash memory controller 110 transmits a bandwidth change request to negotiate with the host device 130 to adjust the PCIe bandwidth. In this embodiment, the new bandwidth corresponds to PCIe 3.0.

After the PCIe bandwidth is adjusted, the flash memory controller 110 starts to sequentially executes the following commands and replies the corresponding data to the host device 130.

It is noted that the step of the flash memory controller 110 requesting and negotiating PCIe bandwidth change is known by a person skilled in the art. Detailed descriptions of the negotiation steps are omitted here.

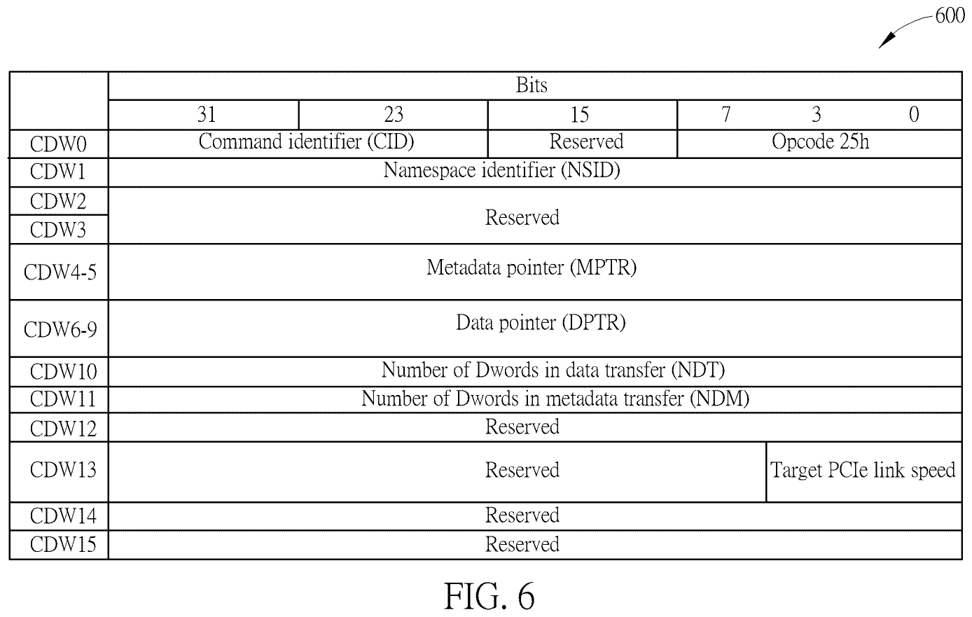

FIG. 6 is a diagram illustrating a specific command 600 for the embodiment shown in FIG. 4 according to one embodiment of the present invention. As shown in FIG. 6, the specific command is a non-volatile memory express (NVMe) admin command, and the host device 130 adds some information in this NVMe admin command to implement the passive mode bandwidth control method shown in FIG. 4. Specifically, the specific command includes multiple command Dwords CDW0-CDW15, and each of CDW0-CDW15 has 32 bits, wherein CDW0 records command identifier (CID) and operation code (opcode), CDW1records namespace identifier (NSID), CDW4-CDW5 record metadata pointer (MPTR), CDW6-CDW9 record data pointer (DPTR), CDW10 records number of Dwords in data transfer (NTD), CDW11 records number of Dwords in metadata transfer (NDM), and the other CDW2, CDW3 and CDW12-CDW15 are reserved space. In this embodiment, the host device 130 sets a specific operation code that is not defined in the NVMe specification, such as “25h” or another value, to notify the flash memory controller 120 that a recommended bandwidth is provided within this command. In addition, the host device 130 sets CDW13 to record a target PCIe link speed (i.e., the recommended bandwidth).

After receiving the specific command shown in FIG. 6, the flash memory controller 110 reads the operation code and performs the bandwidth request in the passive mode, and the flash memory controller 120 sends a bandwidth change request and negotiates with the host device 130 to set new bandwidth based on the recommended bandwidth recorded in the specific command.

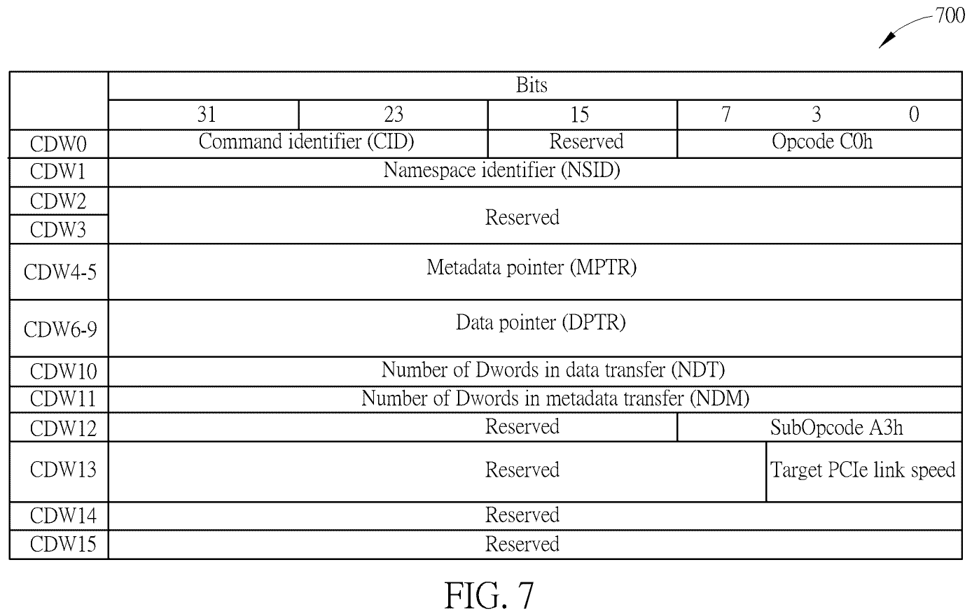

FIG. 7 is a diagram illustrating a specific command 700 for the embodiment shown in FIG. 4 according to one embodiment of the present invention. As shown in FIG. 7, the specific command is an NVMe admin command, and the host device 130 adds some information in this NVMe admin command to implement the passive mode bandwidth control method shown in FIG. 4. Specifically, the specific command includes multiple command Dwords CDW0-CDW15, and each of CDW0 CDW15 has 32 bits, wherein CDW0 records CID and operation code (opcode), CDW1 records NSID, CDW4-CDW5 record MPTR, CDW6-CDW9 record DPTR, CDW10 records NTD, CDW11 records NDM, and the other CDW2, CDW3 and CDW12-CDW15 are reserved space. In this embodiment, the host device 130 sets an vendor specific operation code “C0h” that is defined in the NVMe specification, and further sets a sub-operation code “A3h” in CDW12, to notify the flash memory controller 120 that a recommended bandwidth is provided within this command. In addition, the host device 130 sets CDW13 to record a target PCIe link speed (i.e., the recommended bandwidth).

After receiving the specific command shown in FIG. 7, the flash memory controller 110 reads the operation code and the sub-operation code to perform the bandwidth request in the passive mode, and the flash memory controller 120 sends a bandwidth change request and negotiates with the host device 130 to set a new bandwidth based on the recommended bandwidth recorded in the specific command.

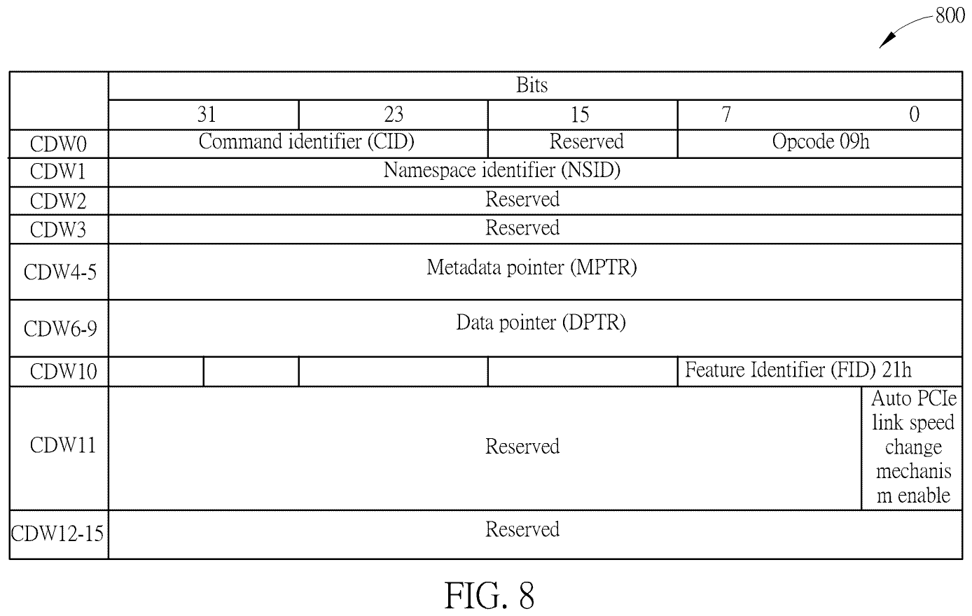

FIG. 8 is a diagram illustrating a specific command 800 for the embodiment shown in FIG. 2 according to one embodiment of the present invention. As shown in FIG. 8, the specific command is an NVMe admin command, and the host device 130 adds some information in this NVMe admin command to implement the active mode bandwidth control method shown in FIG. 2. Specifically, the specific command includes multiple command Dwords CDW0-CDW15, and each of CDW0 CDW15 has 32 bits, wherein CDW0 records CID and operation code (opcode), CDW1 records NSID, CDW4-CDW5 record MPTR, CDW6-CDW9record DPTR, CDW10 records NTD, CDW11 records NDM, and the other CDW2, CDW3 and CDW12-CDW15 are reserved space. In this embodiment, the host device 130 sets a set feature operation code “09h” that is defined in NVMe specification, and further sets a feature identifier “21h” in CDW12, to notify the flash memory controller 120 that a recommended bandwidth is provided within this command, wherein the feature identifiers “00h”-“BFh” are reserved and not defined in NVMe specification. In addition, the host device 130 sets CDW11 to enable an auto PCIe link speed change mechanism (e.g., active mode bandwidth control).

After receiving the specific command shown in FIG. 8, the flash memory controller 110 reads the operation code, sub-operation code and CDW11 to perform the bandwidth request in the active mode, and the flash memory controller 120 sends a bandwidth change request and negotiates with the host device 130 to set a new bandwidth.

Briefly summarized, in the control method of flash memory controller, the flash memory controller can use an active mode or a passive mode to control bandwidth adjustment between the flash memory controller and the host device according to a specific command. In addition, the flash memory controller can determine when to start performing bandwidth adjustment, to prevent the packet loss during the bandwidth adjustment.

Those skilled in the art will readily observe that numerous modifications and alterations of the device and method may be made while retaining the teachings of the invention. Accordingly, the above disclosure should be construed as limited only by the metes and bounds of the appended claims.

1. A control method of a flash memory controller, wherein the flash memory controller is coupled between a host device and a flash memory module, and the flash memory controller is configured to receive a command from the host device to access the flash memory module; and the control method comprises:
setting a first bandwidth for communicating with the host device;
receiving a specific command from the host device; and
transmitting a bandwidth change request to the host device to negotiate with the host device to set a second bandwidth for communicating with the host device according to the specific command.

2. The control method of claim 1, wherein specific command comprises a recommended bandwidth, and the second bandwidth is the recommended bandwidth.

3. The control method of claim 2, wherein the specific command is a non-volatile memory express (NVMe) admin command.

4. The control method of claim 3, wherein the specific command comprises a specific operation code to notify the flash memory controller that the recommended bandwidth is provided, and the specific command further comprises the recommended bandwidth in a reserved space.

5. The control method of claim 1, further comprising:
enabling a bandwidth adjustment mechanism according to the specific command;
determining the second bandwidth; and
the step of transmitting the bandwidth change request to the host device to negotiate with the host device to set the second bandwidth for communicating with the host device according to the specific command comprises:
transmitting the bandwidth change request with the second bandwidth to the host device to negotiate with the host device to set the second bandwidth for communicating with the host device according to the specific command.

6. The control method of claim 5, wherein the step of determining the second bandwidth comprises:
determining the second bandwidth according to a number of commands in a queue that have not yet been executed by the flash memory controller.

7. The control method of claim 5, wherein the step of determining the second bandwidth comprises:
determining the second bandwidth according to a current operation of the flash memory controller.

8. The control method of claim 1, further comprising:
before transmitting the bandwidth change request to the host device, halting packet transmission with the host device.

9. The control method of claim 1, where the first bandwidth corresponds to one of multiple Peripheral Component Interconnect Express (PCIe) versions, and the second bandwidth corresponds to another one of the multiple PCIe versions.

10. A flash memory controller, wherein the flash memory controller is configured to receive a command from a host device to access a flash memory module, and the flash memory controller comprises:
a read-only memory, configured to store a program code;
a microprocessor, configured to execute the program code to control access of the flash memory module; and
an interface logic, coupled between the microprocessor and the host device;
wherein the microprocessor and the interface logic are configured to perform the steps of:
setting a first bandwidth for communicating with the host device;
receiving a specific command from the host device; and
transmitting a bandwidth change request to the host device to negotiate with the host device to set a second bandwidth for communicating with the host device according to the specific command.

11. The flash memory controller of claim 10, wherein specific command comprises a recommended bandwidth, and the second bandwidth is the recommended bandwidth.

12. The flash memory controller of claim 11, wherein the specific command is a non-volatile memory express (NVMe) admin command.

13. The flash memory controller of claim 12, wherein the specific command comprises a specific operation code to notify the flash memory controller that the recommended bandwidth is provided, and the specific command further comprises the recommended bandwidth in a reserved space.

14. The flash memory controller of claim 10, further comprising:
enabling a bandwidth adjustment mechanism according to the specific command;
determining the second bandwidth; and
the step of transmitting the bandwidth change request to the host device to negotiate with the host device to set the second bandwidth for communicating with the host device according to the specific command comprises:
transmitting the bandwidth change request with the second bandwidth to the host device to negotiate with the host device to set the second bandwidth for communicating with the host device according to the specific command.

15. The flash memory controller of claim 14, wherein the step of determining the second bandwidth comprises:
determining the second bandwidth according to a number of commands in a queue that have not yet been executed by the flash memory controller.

16. The flash memory controller of claim 14, wherein the step of determining the second bandwidth comprises:
determining the second bandwidth according to a current operation of the flash memory controller.

17. The flash memory controller of claim 10, further comprising:
before transmitting the bandwidth change request to the host device, halting packet transmission with the host device.

18. The flash memory controller of claim 10, where the first bandwidth corresponds to one of multiple Peripheral Component Interconnect Express (PCIe) versions, and the second bandwidth corresponds to another one of the multiple PCIe versions.

19. A memory device, comprising:
a flash memory module; and
a flash memory controller, configured to receive a command from a host device to access the flash memory module;
wherein the flash memory controller is configured to perform the steps of:
setting a first bandwidth for communicating with the host device;
receiving a specific command from the host device; and
transmitting a bandwidth change request to the host device to negotiate with the host device to set a second bandwidth for communicating with the host device according to the specific command.

20. The memory device of claim 19, further comprising:
enabling a bandwidth adjustment mechanism according to the specific command;
determining the second bandwidth; and
the step of transmitting the bandwidth change request to the host device to negotiate with the host device to set the second bandwidth for communicating with the host device according to the specific command comprises:
transmitting the bandwidth change request with the second bandwidth to the host device to negotiate with the host device to set the second bandwidth for communicating with the host device according to the specific command.
